(19) United States
(12) Patent Application Publication
(10) Pub. No.: US 2023/0072829 A1
(43) Pub. Date: Mar. 9, 2023

(54) SYSTEM FOR PERSONAL AUTHENTICATION AND WEBSITE LOGIN USING USB

(71) Applicant: Banghyun CHOI, Bucheon-si (KR)

(72) Inventor: Banghyun CHOI, Bucheon-si (KR)

(21) Appl. No.: 17/507,988

(22) Filed: Oct. 22, 2021

(30) Foreign Application Priority Data
Sep. 9, 2021 (KR) 10-2021-0120251

(51) Int. Cl. H04L 29/06

(52) U.S. Cl. CPC H04L 63/0861; H04L 63/0876; H04L 63/102

(57) ABSTRACT

A system for personal authentication and website login using a USB according to the present invention comprises: a server; a smartphone connected to the server, capable of short-range communication via a first communication module, and recognizing a user's biometric information via a sensing means; a PC connected to the server and displaying a website; and a USB device physically connected to the PC, having a second communication module, and connected to the first communication module via short-range communication, wherein the smartphone includes an application that checks connection state of the first and the second communication module, that determines whether the recognized user's biometric information is identical to pre-registered biometric information, and that provides a determination result to the server, thereby enabling automatical personal authentication and ID login on the website of the PC that the USB device is connected to.

### FIELD OF THE INVENTION

The present invention relates to a system for personal authentication and website login using a USB. The invention allows a user to easily perform personal authentication using a smartphone and a USB connected to a computer, and maintain the login state when accessing online banking websites, civil service websites, and various websites requiring personal authentication, thereby increasing user convenience and enhancing security.

### BACKGROUND OF THE INVENTION

In general, when using an internet website, a login process is performed in such a way that a login ID and a password are stored through membership registration to identify an individual, and the website confirms whether the login ID and password are matched.

In particular, on online banking sites where financial transactions are made and civil service website for viewing personal information, the websites check not only whether the login ID and password match, but also require an accredited certificate. For personal authentication using the accredited certificate, a user needs to be issued an accredited certificate from the accredited certification authority, connects the website to a location where the issued accredited certificate is stored, and then submits a password of the accredited certificate.

However, the website login process completely depends on the user's memory, and the login process is performed in such a way that a user recalls his or her login ID and password and enters them on the website. In this instance, if a user uses the same login ID and password for various websites, they can memorize the single set of login ID and password. However, if different login IDs and passwords are used for multiple websites, the user is likely to experience inconvenience by entering a wrong password. This inconvenience is exacerbated as the number of websites that the user uses increases.

In addition, because the websites require a user to have a password having a combination of numbers, English letters, and special characters with a long, complicated form to enhance security, users have more difficulties in memorizing passwords.

Furthermore, when a user needs to perform personal authentication with an accredited certificate, it is inconvenient to enter a password whenever a user uses the website. In case of online banking websites, a user needs to consistently extend a login state to stay on the website. If the user does not extend the login state and exceeds a certain amount of time, the user is logged out automatically, thereby causing inconvenience.

Moreover, in the case of a public PC, if other user uses the PC after the previous user left the PC without logging out, there is a security problem in that personal information may be leaked because the previous user's ID is logged in.

### PRIOR ARTS

### Patent Document

(Patent Document 0001) Korean Patent Registration No. 10-1469046
(Patent Document 0002) Korean Patent Registration No. 10-1652625
(Patent Document 0003) Korean Patent Registration No. 10-1850677

### Technical Problem

The present invention has been devised to solve the problems mentioned above, and aims to provide a system for personal authentication and website login using a USB that can maintain a login state or allow personal authentication using a user's biometric information and the USB without entering a login ID and a password, to increase user convenience and enhance security with a personal smartphone and the USB, when accessing a website or performing personal authentication.

### SUMMARY OF THE INVENTION

A system for personal authentication and website login using a USB, the system comprising: a server 100; a smartphone 200 connected to the server 100 through internet, capable of short-range communication through a first communication module 210, and recognizing a user's biometric information through a sensing means 220 equipped therein; a PC 300 connected to the server 100 and displaying a website that the PC 300 accesses to; and a USB device 400 physically connected to the PC 300, having a second communication module 410, and connected to the first communication module 210 of the smartphone 200 through short-range communication, wherein the smartphone 200 includes an application 230 that checks connection state of the first and the second communication module 210, 410 in real time, that determines whether user's biometric information recognized through the sensing means 220 is identical to pre-registered biometric information, and that provides a determination result to the server 100, thereby enabling automatical personal authentication and ID login on the website of the PC 300 that the USB device 400 is connected to.

In addition, when the application 230 recognizes disconnection between the first and the second communication module 210, 410, the application 230 commands the server 100 to forcibly log out the ID that is logged in on the website.

Furthermore, the USB device 400 stores files related to personal authentication, and the files on the USB device 400 is used after the USB device 400 is registered through the application 230 of the smartphone 200.

Moreover, the PC 300 that the USB device 400 is connected to is specified by a process of: a step that the USB device 400 identifies the IP information of the PC 300 that the USB device 400 is connected to, and then transmits the IP information of the PC 300 to the application 230 through the short-range communication of the first and the second communication module 210, 410, and a step that the application 230 provides the IP information of the PC 300 transmitted from the USB device 400 to the server 100.

### Advantageous Effects

The present invention enables a user to log in on websites, maintain the login state, and perform personal authentication using the user's biometric information and a USB without entering a login ID and a password when accessing websites or performing personal authentication, thereby increasing user convenience and enhancing security with a personal smartphone and the USB.

### BRIEF DESCRIPTION OF THE DRAWINGS

FIG. 1 is a concept drawing schematically illustrating a system for personal authentication and website login using a USB of the present invention.

FIG. 2 is a diagram illustrating system for personal authentication and website login using a USB of the present invention.

### DETAILED DESCRIPTION EMBODIMENTS OF THE INVENTIONS

Hereinafter, preferred embodiments of the present invention will be described in detail in conjunction with the accompanying drawings. In addition, detailed descriptions of well-known functions and configurations that may blur the gist of the present invention will be omitted.

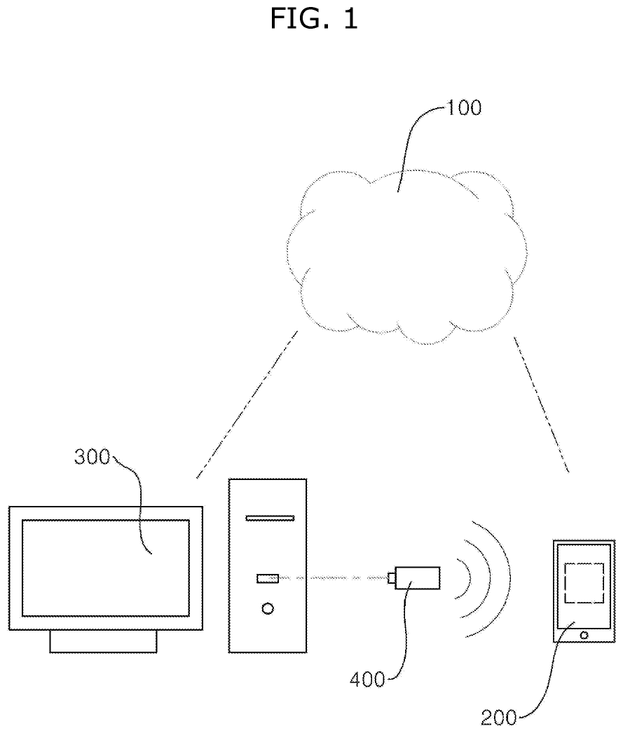

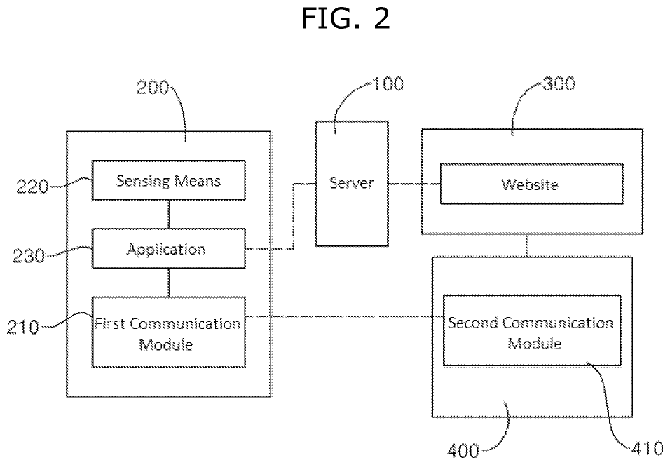

As illustrated in FIGS. 1 and 2, a system for personal authentication and website login using a USB of the present invention comprises: a server 100; a smartphone 200 connected to the server 100 through internet, capable of short-range communication through a first communication module 210, and recognizing user's biometric information through a sensing means 220 equipped therein; a PC 300 connected to the server 100 and displaying a website that the PC 300 accesses to; and a USB device 400 physically connected to the PC 300, having a second communication module 410, and connected to the first communication module 210 of the smartphone 200 through short-range communication, wherein the smartphone 200 includes an application 230 that checks connection state of the first and the second communication module 410 in real time, that determines whether user's biometric information recognized through the sensing means 220 is identical to the pre-registered biometric information, and that provides a determination result to the server 100, thereby enabling automatical personal authentication and ID login on the website of the PC 300 that the USB device 400 is connected to.

The first communication module 210 of the smartphone 200 is a short-range communication module built-in to the smartphone 200 and means short-range communication such as Bluetooth. The sensing means 220 equipped in the smartphone 200 may indicate various kinds of means capable of recognizing the biometric information of the user. For example, considering the current level of technology, the most preferred embodiments may be face recognition through a camera and fingerprint recognition using a touch panel. However, as technology in the field of the smartphone 200 advances in the future, the user can be identified by recognition of user's iris, voice, smell, skin color, and others.

The PC 300 is one that the user uses for visiting websites. The PC 300 is connected to the server 100 through the internet and can display various websites. In this instance, the website displayed on the PC 300 may be a website simply requiring an ID login, and may be an online banking or websites related to government office and civil service center that require personal authentication as well as login.

The USB device 400 of the present invention is a component that is physically connected to a USB port that is built-in to the PC 300 and that includes the second communication module 410. The second communication module 410, which is not included in conventional USBs, is built-in to the USB device 400. The second communication module 410 is for short-range communication such as the first communication module 210 of the smartphone 200 and Bluetooth. When the USB device 400 is connected to the PC 300, power of the PC 300 is supplied to the USB device 400, thereby activating the second communication module 410.

When the second communication module 410 is activated as the USB device 400 is connected to the PC 300, the second communication module 410 is connected to the first communication module 210 of the smartphone 200 located in short-range. In this process, a user runs the application 230 of the smartphone 200 connected to the short-range communication and enters the user's biometric information. If the user's biometric information is determined to be identical with the pre-stored biometric information, the application 230 commands the server 100 to perform personal authentication and login on the website displayed on the PC 300 that the USB device 400 is connected to.

In addition, when the application 230 recognizes disconnection between the first and the second communication module 210, 410, the application 230 commands the server 100 to forcibly log out the ID that is logged in on the website.

As described above, the USB device 400 serves as a mediator connecting the PC 300 and the smartphone 200. At the same time, because the distance between the USB device 400 and the smartphone 200 has to be within communication range of the first and the second communication module 210, 410 for the authentication process, there is no security problem even if the USB device 400 is lost. In addition, in case of using a public PC 300, even if users change at a certain PC 300 while the previous user's USB device 400 is still connected to the PC 300, the previous user's personal information can be protected from being leaked to others because the connection between the USB device 400 and the smartphone 200 is lost when the previous user leaves the PC 300 and is out of the communication range.

Furthermore, because the USB device 400 has data storage function as well as communication connection function, data related to the user's biometric information can be encrypted and stored. The user's biometric information may be stored in the server 100 through the application 230. However, if the biometric information is stored in the USB device 400, the load of the server 100 can be minimized especially when a number of users simultaneously attempt recognition of biometric information. Furthermore, personal information leakage can be minimized by hacking the server 100.

The USB device 400 of the present invention may store files related to personal authentication, and the files on the USB device may be used after the USB device 400 is registered through the application 230 of the smartphone 200. Because only the registered USB device 400 can be used for login or personal authentication, security can be strengthened.

In addition, in order to perform login and personal authentication of a certain PC 300 in the server 100, the PC 300 that the USB device 400 is connected to has to be specified. In this instance, there may be various methods. One of them may be a method of registering an IP address of the PC 300 on a website by logging in on the website by entering an ID and a password using the PC 300. Another may be a method of manually inputting the IP address of the PC 300 to be registered through.

Furthermore, as another method, the USB device 400 identifies the IP information of the PC 300 that the USB device 400 is connected to, and then transmits the IP information of the PC 300 to the application 230 through the short-range communication of the first and the second communication module 210, 410. The application 230 provides the IP information of the PC 300 transmitted from the USB device 400 to the server 100. In this way, the PC 300 that the USB device 400 is connected to can be specified.

While the application 230 of the smartphone 200 is running, when the USB device 400 is directly connected to the PC 300, the user provides his or her biometric information using the smartphone 200, and the application 230 recognizes the user's biometric information, personal authentication or login process on the website is automatically performed without a separate login process on the PC 300 if the user completes membership registration on the website or personal information of the application 230 is registered on the website.

Embodiments of the present invention described above are to be considered illustrative, and the present invention may be varied or modified within the true spirit and scope of the inventive concept.

What is claimed is:

1. A system for personal authentication and website login using a USB, the system comprising:
a server 100;
a smartphone 200 connected to the server 100 through internet, capable of short-range communication through a first communication module 210, and recognizing a user's biometric information through a sensing means 220 equipped therein;
a PC 300 connected to the server 100 and displaying a website that the PC 300 accesses to, and
a USB device 400 physically connected to the PC 300, having a second communication module 410, and connected to the first communication module 210 of the smartphone 200 through short-range communication,
wherein the smartphone 200 includes an application 230 that checks connection state of the first and the second communication module 210, 410 in real time, that determines whether user's biometric information recognized through the sensing means 220 is identical to pre-registered biometric information, and that provides a determination result to the server 100, thereby enabling automatical personal authentication and ID login on the website of the PC 300 that the USB device 400 is connected to.

2. The system of claim 1, wherein when the application 230 recognizes disconnection between the first and the second communication module 210, 410, the application 230 commands the server 100 to forcibly log out the ID that is logged in on the website.

3. The system of claim 1, wherein the USB device 400 stores files related to personal authentication, and the files on the USB device 400 is used after the USB device 400 is registered through the application 230 of the smartphone 200.

4. The system of claim 1, wherein the PC 300 that the USB device 400 is connected to is specified by a process of:
a step that the USB device 400 identifies the IP information of the PC 300 that the USB device 400 is connected to, and then transmits the IP information of the PC 300 to the application 230 through the short-range communication of the first and the second communication module 210, 410, and
a step that the application 230 provides the IP information of the PC 300 transmitted from the USB device 400 to the server 100.
